(19) United States
(12) Patent Application Publication
(10) Pub. No.: US 2015/0022146 A1
(43) Pub. Date: Jan. 22, 2015

(54) SYSTEM COMPOSED OF A HAND TOOL CASE AND A HAND TOOL BATTERY

(71) Applicant: Brett Huber, Arlington Heights, IL (US)

(72) Inventor: Brett Huber, Arlington Heights, IL (US)

(21) Appl. No.: 14/359,480

(22) PCT Filed: Nov. 12, 2012
(86) PCT No.: PCT/EP2012/072366

§ 371 Date: May 20, 2014

(30) Foreign Application Priority Data
Nov. 22, 2011 (DE) 10 2011 086 875.5

(51) Int. Cl. H02J 7/02; H02J 7/00

(52) U.S. Cl. CPC H02J 7/025; H02J 7/0045
USPC 320/108

(57) ABSTRACT

A system having a hand tool case which includes at least one inductive charge receiving area, and at least one hand tool battery which is provided for being inductively charged. The inductive charge receiving area is provided for storing the hand tool battery at least partially in close proximity to at least one wall of the hand tool case.

### FIELD OF THE INVENTION

The present invention relates to A system having a hand tool case which includes at least one inductive charge receiving area, and at least one hand tool battery which is provided for being inductively charged.

### BACKGROUND INFORMATION

Systems composed of a hand tool case and a hand tool battery are already known.

### SUMMARY OF THE INVENTION

The present invention relates to a hand tool case which has at least one inductive charge receiving area, and at least one tool battery which is provided for being inductively charged, the charge receiving area being provided for storing a hand tool battery at least partially in close proximity to at least one wall of the hand tool case.

A “hand tool case” is understood in particular to mean a transport container which is provided for accommodating at least one hand tool battery and what may be at least one hand tool. In particular, the hand tool case has an at least essentially cuboidal shape. The statement that an object has an “essentially cuboidal” configuration is understood in particular to mean that there is at least one cuboid which is situated completely within the object and which encompasses at least 70%, in particular at least 80%, advantageously at least 90%, which may be at least 95%, of the points of the object.

In particular, in at least one main direction of extension, the “height,” the hand tool case has an extension which corresponds to 70% maximum, in particular 50% maximum, advantageously 30% maximum, which may be 10% maximum, of an extension along a further main direction of extension, the “width.” Alternatively, configurations of the hand tool case having an at least essentially cube-like shape are conceivable. A “main direction of extension” is understood in particular to mean a main axis of inertia. Two main directions of extension may be situated perpendicularly with respect to one another. The hand tool case may have an extension of at least 20 cm, in particular at least 25 cm, advantageously at least 35 cm, and 80 cm maximum, in particular 70 cm maximum, advantageously 50 cm maximum, along the width. The hand tool case may have an extension of at least 5 cm, in particular at least 7 cm, advantageously at least 9 cm, and 20 cm maximum, in particular 15 cm maximum, advantageously 12 cm maximum, along the height. In particular, on at least one lateral surface the hand tool case has a handle which in particular is provided for carrying and/or hanging the hand tool case in a vertical orientation in which the height of the hand tool case is oriented at least essentially in parallel to the horizontal.

In particular, the hand tool case has at least one handle situated on a top side, in particular on the lid, and/or at least two handles which are situated on opposite lateral surfaces and which in particular are provided for carrying and/or hanging the hand tool case in a horizontal orientation in which the height of the hand tool case is oriented at least essentially perpendicularly with respect to the horizontal. The term “essentially parallel” is understood in particular to mean an angle of less than 30°, in particular less than 15°, advantageously less than 5°, which may be less than 1°. The term “essentially perpendicularly” is understood in particular to mean an angle that deviates from 90° by less than 30°, in particular by less than 15°, advantageously by less than 5°, which may be by less than 1°. In particular, the handles are pivotable and may be retractable into the hand tool case. In particular, the hand tool case has at least two housing parts which form an outer delimitation of the hand tool case. In particular, the housing parts are connected to one another via a hinge mechanism and/or a slide mechanism. In particular, at least one of the housing parts is configured as a shell, and, together with at least one interior structuring element which is situated in the housing part which is configured as a shell and/or is configured in one piece with the housing part, is provided for providing at least one inductive charge receiving area. In particular, at least one of the housing parts is configured as a lid. In particular, the housing part configured as a lid is provided for closing off the hand tool case in a watertight manner. An “inductive charge receiving area” is understood in particular to mean a receiving area of the hand tool case which is provided for accommodating at least one hand tool battery and to assist in inductive charging of a hand tool battery which is inserted into the inductive charge receiving area.

In particular, the inductive charge receiving area is provided for allowing charging of the hand tool battery with an efficiency of at least 70%, in particular at least 80%, advantageously at least 90%, which may be at least 95%. In particular, the inductive charge receiving area allows inductive charging of the hand tool battery through a wall of the hand tool case. In particular, the inductive charge receiving area is provided for accommodating a hand tool battery which is mechanically and/or electrically connected to a hand tool and/or integrated into a hand tool. The housing parts, at least those situated in close proximity to the inductive charge receiving area, may be made of an insulating material in order to avoid small losses during energy transmission via induction. The term “provided” is understood in particular to mean specially configured and/or equipped. The statement that a hand tool battery is provided for being “inductively” charged is understood in particular to mean that the hand tool battery has at least one charging coil. In addition, the hand tool battery has at least one coupling site which is provided for mechanically connecting the hand tool battery to a hand tool. In particular, the coupling site is part of a detent mechanism and/or twist-on mechanism. A “charging coil” is understood in particular to mean a coil having at least one twisted, in particular wound, electrical conductor which is provided for sending and/or may be for receiving, in at least one operating state, energy for charging and/or discharging, in particular of at least one, which may be electrochemical, energy storage unit of the hand tool battery.

Alternatively, the charging coil is formed by a printed conductor situated on a printed circuit board. The charging coil may be provided for converting an electrical alternating current into a magnetic alternating field and/or vice versa. In particular, the charging coil is provided for supplying received energy directly to a consumer, in particular via a voltage transformer. A system having a hand tool battery and a charging device and/or a hand tool may have at least two mutually coordinated charging coils which are spatially separable by an operator, in at least one operating state at least one charging coil being provided for generating a magnetic alternating field which induces an electrical alternating current in at least one additional charging coil. In particular, the hand tool battery has an electronics system which is provided for converting an alternating current which is induced in the charging coil into a direct current which is storable in the energy storage unit, and/or for converting a direct current which is withdrawn from the energy storage unit into an alternating current in order to thus feed the charging coil and transmit energy to a corresponding charging coil.

The statement that the hand tool battery is stored at least “partially in close proximity to” a wall is understood in particular to mean that at least 2% by volume, in particular at least 5% by volume, which may be at least 10% by volume, of the hand tool battery, and in particular at least 10% by volume, advantageously at least 30% by volume, which may be at least 50% by volume, of the charging coil, are situated at a distance of 25 mm maximum, in particular 20 mm maximum, advantageously 15 mm maximum, which may be 10 mm maximum, from the wall. A “wall” is understood in particular to mean an integral part of the hand tool case which is provided for forming an outer delimitation of the hand tool case. In particular, the wall has a material thickness of less than 8 mm, in particular less than 5 mm, advantageously less than 3 mm, which may be less than 2 mm. In particular, effective charging may be achieved.

In addition, it is provided that the inductive charge receiving area is provided for storing the hand tool battery over a large area on the at least one wall of the hand tool case. The statement that an object is stored “over a large area” on a side is understood in particular to mean that at least 2%, in particular at least 5%, advantageously at least 9%, particularly advantageously at least 14%, which may be at least 20%, of the outer surface of the hand tool battery is situated at a distance of less than 5 mm, in particular less than 3 mm, which may be less than 2 mm, from the wall. In particular, effective charging may be achieved.

In addition, it is provided that the hand tool battery has at least one charging coil which, at least in an accommodated state, is situated at least essentially in parallel to the wall of the hand tool case. In particular, effective charging may be achieved. The at least one charging coil, at least during a charging operation, may be situated at least essentially in parallel to a corresponding charging coil of a charging device.

In another embodiment of the present invention, it is provided that the charging coil is situated on a bottom side of the hand tool battery. A “bottom side” of the hand tool battery is understood in particular to mean a side of the hand tool battery which is opposite from a side which has the coupling site. In particular, a simple configuration of the hand tool battery may be achieved.

In addition, it is provided that the charging coil is situated on an outer side of the hand tool battery. An “outer side” is understood in particular to mean a side of the hand tool battery that is different from a side which has the coupling site, and different from a bottom side. In particular, a simple configuration of a corresponding charging station may be achieved, with the aid of a simple configuration it being possible in particular to charge even large hand tool batteries.

In addition, it is provided that the at least one wall forms a bottom side of the hand tool case. A “bottom side” of the hand tool case is understood in particular to mean a side which is opposite from the lid. In particular, the bottom side is oriented at least essentially perpendicularly with respect to the height. In particular, a simple configuration of a corresponding charging device may be achieved.

In addition, it is provided that the at least one wall forms an outer side of the hand tool case. An “outer side” of the hand tool case is understood in particular to mean a side which is oriented at least essentially in parallel to the height of the hand tool case. In particular, charging of large hand tool batteries and/or hand tool batteries coupled to hand tools which have a charging coil situated on a base of the hand tool battery may be made possible.

In addition, it is provided that the outer side of the hand tool case forms a rear side of the hand tool case. A “rear side” of the hand tool case is understood in particular to mean an outer side which has no handle. In particular, the rear side has stands which are provided in particular for corresponding to a hand tool case holding device which is configured in particular as a charging station for inductive charging. Alternatively, an arrangement of the charging coil on a front side which is situated opposite from the rear side and which in particular has a handle, and which in particular is situated close to the handle, is conceivable. In particular, a simple configuration may be achieved.

Further advantages result from the following description of the drawings. Three exemplary embodiments of the present invention are illustrated in the drawings. The drawings, the description, and the claims contain numerous features in combination. Those skilled in the art will also advantageously consider the features individually and combine them into further meaningful combinations.

### BRIEF DESCRIPTION OF THE DRAWINGS

FIG. 1 shows a system according to the present invention having a hand tool battery according to the present invention and a hand tool case according to the present invention in a schematic illustration.

FIG. 2 shows a section of a system according to the present invention.

FIG. 3 shows a section of an alternative system according to the present invention.

FIG. 4 shows a section of another alternative system according to the present invention.

### DETAILED DESCRIPTION

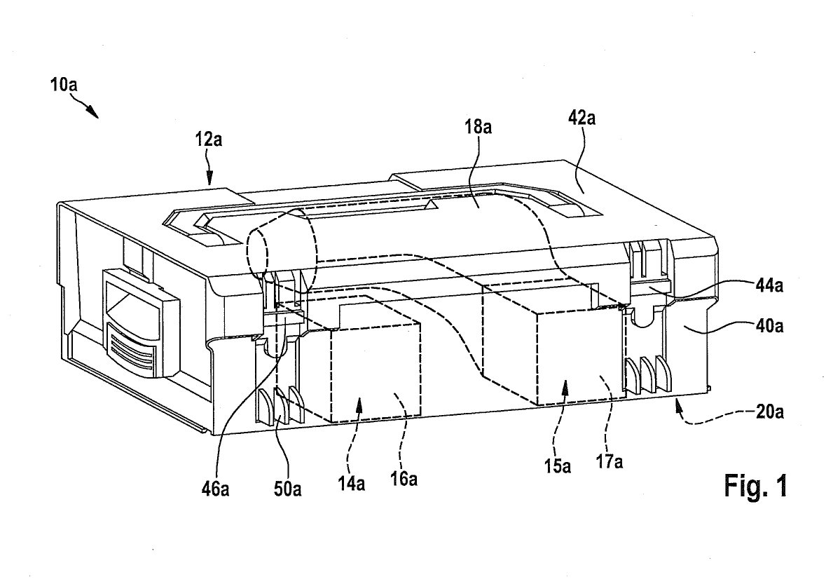

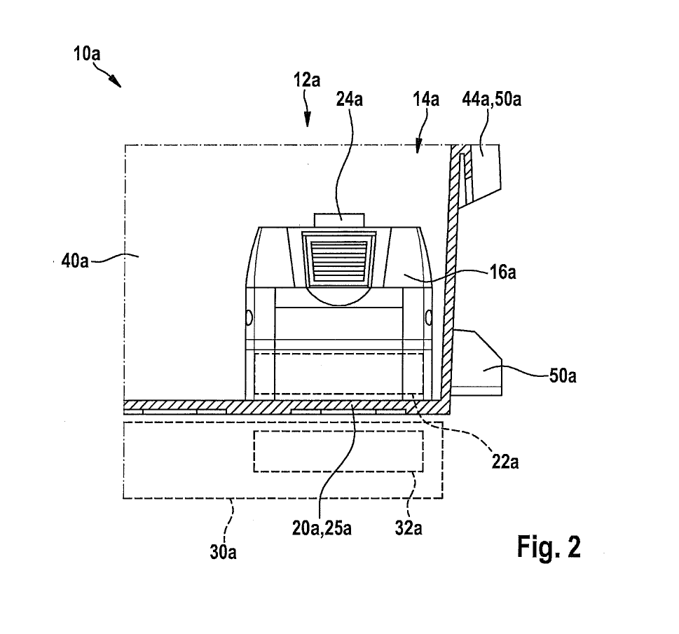

FIG. 1 shows a system 10a having a hand tool case 12a which includes two inductive charge receiving areas 14a, 15a, and a hand tool battery 16a which is provided for being inductively charged. In addition, system 10a has a hand tool 18a with a coupled hand tool battery 17a. Inductive charge receiving areas 14a, 15a are provided for storing hand tool batteries 16a, 17a, respectively, partially in close proximity to a wall 20a of hand tool case 12a. Inductive charge receiving area 14a is provided for storing hand tool battery 16a over a large area on wall 20a of hand tool case 12a (FIG. 2). Hand tool battery 16a has a charging coil 22a which in an accommodated state is situated in parallel to wall 20a of hand tool case 12a. Charging coil 22a is situated on a bottom side of hand tool battery 16a opposite from a coupling area 24a. Wall 20a forms a bottom side of hand tool case 12a. Hand tool case 12a has two housing parts 40a, 42a. Housing part 40a is configured as a shell. Housing part 42a is configured as a lid. Housing parts 40a, 42a are coupled via hinges 44a, 46a and are provided for being fixed to one another via a detent mechanism (not illustrated). Alternatively, slide mechanisms are also conceivable for the fixing. Hinges 44a, 46a are at the same time configured as stands 50a. In addition, a corresponding charging station 30a having a charging coil 32a is indicated in FIG. 2.

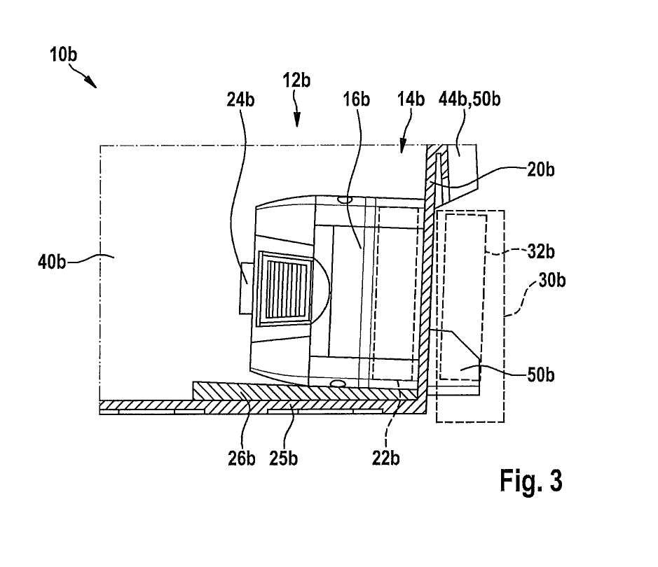

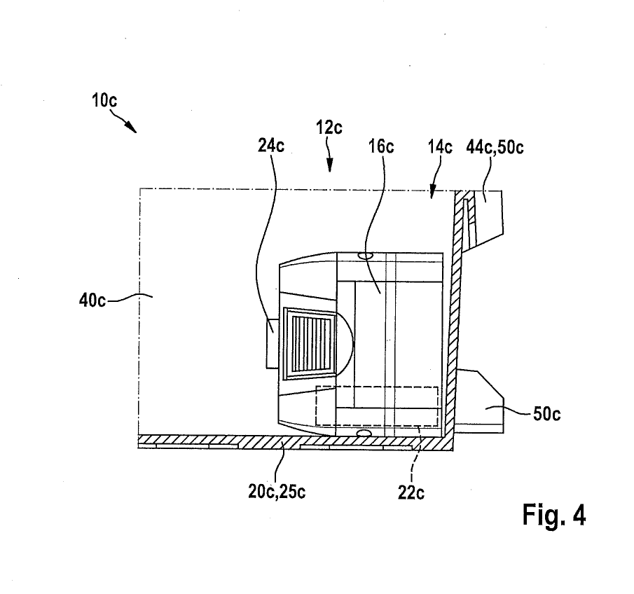

Two further exemplary embodiments of the present invention are shown in FIGS. 3 and 4. The following descriptions and the drawings are limited essentially to the differences between the exemplary embodiments; with regard to components denoted in the same way, in particular components having the same reference numerals, reference may basically also be made to the drawings and/or the description of the other exemplary embodiments, in particular for FIGS. 1 and 2. To differentiate between the exemplary embodiments, the letter “a” is added as a suffix to the reference numerals of the exemplary embodiment in FIGS. 1 and 2. In the exemplary embodiments in FIGS. 3 and 4, the letter “a” is replaced by the letters “b” and “c,” respectively.

FIG. 3 schematically shows one embodiment of a system 10b, a wall 20b of a hand tool case 12b, in the close proximity of which a hand tool battery 16b is inserted, forming an outer side of hand tool case 12b. A charging coil 22b of hand tool battery 16b is situated in parallel to wall 20b. Wall 20b has an angle of 92° with respect to a bottom side 25b of hand tool case 12b, thus simplifying loading of hand tool case 12b. A ramp 26b having an angle of 2° assists with contacting wall 20b over a large area. The outer side forms a rear side of hand tool case 12b. Stands 50b are situated on the rear side, which forms wall 20b.

FIG. 4 schematically shows one embodiment of a system 10c, a hand tool battery 16c having a charging coil 22c which is situated on an outer side of hand tool battery 16c. Charging coil 22c is situated in parallel to a wall 20c which forms a bottom side of a hand tool case 12c.

Alternatively, charging coil 22c may be situated on a bottom side of hand tool battery 16c, an air gap having an opening angle of 2° being present between the bottom side of hand tool battery 16c and the bottom side of hand tool case 12c.

Alternatively, the hand tool battery may be configured in such a way that the bottom side is tilted by 92° with respect to a lateral surface which rests against a bottom side of the hand tool case, so that the hand tool battery contacts walls of the hand tool case at two main surfaces. In addition, it is conceivable for the hand tool battery to have more than one charging coil in order to be compatible with different charging systems.

In addition, it is conceivable for hand tool batteries 16a, 16b, 16c in the various examples to be displaced in parallel to walls 20a, 20b, 20c, respectively, in order to make room for padding of hand tool battery 16a, 16b, 16c. Furthermore, hand tool battery 17a which is coupled to hand tool 18a may have a similar configuration in the described variations. Hand tool battery 17a advantageously has the same configuration as hand tool battery 16a.

1-10. (canceled)

11. A system, comprising:
a hand tool case which includes at least one inductive charge receiving area and at least one hand tool battery which is inductively chargeable;
wherein the inductive charge receiving area is for storing the hand tool battery at least partially in close proximity to at least one wall of the hand tool case.

12. The system of claim 11, wherein the inductive charge receiving area is for storing the hand tool battery over a large area on the at least one wall of the hand tool case.

13. The system of claim 11, wherein the hand tool battery has at least one charging coil which, at least in an accommodated state of the hand tool battery in the inductive charge receiving area, is situated at least essentially in parallel to the wall of the hand tool case.

14. The system of claim 11, wherein the hand tool battery has at least one charging coil which is situated on a bottom side of the hand tool battery.

15. The system of claim 11, wherein the hand tool battery has at least one charging coil which is situated on an outer side of the hand tool battery.

16. The system of claim 11, wherein the at least one wall forms a bottom side of the hand tool case.

17. The system of claim 11, wherein the at least one wall forms an outer side of the hand tool case.

18. The system of claim 17, wherein the outer side of the hand tool case forms a rear side of the hand tool case.

19. A hand tool case of a system, comprising:
a hand tool case arrangement which includes at least one inductive charge receiving area for receiving at least one hand tool battery which is inductively chargeable, the system including the hand tool case arrangement and the at least one hand tool battery;
wherein the inductive charge receiving area is for storing the hand tool battery at least partially in close proximity to at least one wall of the hand tool case arrangement.

20. A hand tool battery of a system, comprising:
at least one hand tool battery which is inductively chargeable for a hand tool case which includes at least one inductive charge receiving area, which is for receiving the at least one hand tool battery, the system including the hand tool case and the at least one hand tool battery;
wherein the inductive charge receiving area is for storing the hand tool battery at least partially in close proximity to at least one wall of the hand tool case.
